(19) United States
(12) Patent Application Publication
(10) Pub. No.: US 2020/0148117 A1
(43) Pub. Date: May 14, 2020

(54) VEHICLE VISUAL RECOGNITION DEVICE

(71) Applicant: KABUSHIKI KAISHA TOKAI-RIKA-DENKI-SEISAKUSHO, Aichi (JP)

(72) Inventors: Suguru FUJISAKI, Aichi (JP); Shigeki YOSHIDA, Aichi (JP); Isao SUMI, Aichi (JP)

(21) Appl. No.: 16/330,629

(22) PCT Filed: Aug. 25, 2017
(86) PCT No.: PCT/JP2017/030599

§ 371 Date: Mar. 5, 2019

(30) Foreign Application Priority Data
Sep. 16, 2016 (JP) 2016-182304

(51) Int. Cl. B60R 1/072

(52) U.S. Cl. CPC B60R 1/072

(57) ABSTRACT

In a vehicle door mirror device, reinforcement is fixed at a vehicle front side of a visor body. A mirror face adjustment mechanism is covered from the vehicle front side by a bottom wall portion of the reinforcement. The mirror face adjustment mechanism can accordingly be assembled at the inside of a covering wall from the vehicle front side of the visor body in a state in which the reinforcement has not been fixed at the vehicle front side of the visor body, thereby enabling ease of assembly to be improved. Moreover, partitioning walls are provided to a step portion of the reinforcement, thereby enabling the rigidity of the reinforcement to be improved, and enabling support rigidity of a mirror body by a swing body to be more effectively raised.

### TECHNICAL FIELD

The present invention relates to a vehicle visual recognition device in which a visual recognition section assists visual recognition by an occupant of a vehicle.

### BACKGROUND ART

In an electric door mirror disclosed in Japanese Patent Application Laid-Open (JP-A) No. 2013-67194, a motor holder of a mirror face angle adjustment unit is fixed to a dividing wall of a housing body, a mirror is assembled to a pivot plate of the mirror face angle adjustment unit, and the housing body houses the mirror face angle adjustment unit and the mirror.

In the mirror face angle adjustment unit, the motor holder covers the motor from the opposite side to the mirror.

It would be preferable to improve the ease of assembly of such electric door mirrors.

### SUMMARY OF INVENTION

### Technical Problem

In consideration of the above circumstances, an object of the present invention is to obtain a vehicle visual recognition device capable of improving ease of assembly.

### Solution to Problem

A vehicle visual recognition device of a first aspect of the present disclosure includes a visual recognition section, an operating mechanism, a housing body, a covering member, and a reinforcing section. The visual recognition section assists visual recognition by an occupant of a vehicle. The operating mechanism is operated so as to tilt the visual recognition section. The housing body houses the visual recognition section. The covering member includes a covering section to cover the operating mechanism from the opposite side to the visual recognition section. Moreover, the covering member is fixed to the housing body, is bent with respect to the covering section at a first bend portion joined to the covering section, and includes a first extension portion extending from the first bend portion. The reinforcing section projects from the first extension portion and reinforces the covering member.

According to the vehicle visual recognition device of the first aspect of the present disclosure, the covering section of the covering member covers the operating mechanism from the opposite side to the visual recognition section. This thereby enables the operating mechanism to be assembled from the opposite side of the housing body to the visual recognition section in a state in which the covering member has not been fixed on the opposite side of the housing body to the visual recognition section, enabling the ease of assembly to be improved.

The covering member is bent with respect to the covering section at the first bend portion that is joined to the covering section, and the first extension portion extends from the first bend portion. The reinforcing section projects from the first extension portion of the covering member, and is thus capable of reinforcing the covering member.

A vehicle visual recognition device of a second aspect of the present disclosure is the vehicle visual recognition device of the first aspect, wherein the reinforcing section is provided at a portion of the covering member that includes the first bend portion, and is joined to both the covering section and the first extension portion.

According to the vehicle visual recognition device of the second aspect of the present disclosure, the reinforcing section is provided at a portion of the covering member including the first bend portion, and is joined to the covering section and the first extension portion. This thereby enables the covering member to be reinforced at the first bend portion and at portions in the vicinity thereof.

A vehicle visual recognition device of a third aspect of the present disclosure is the vehicle visual recognition device of the first aspect or the second aspect, wherein the covering member includes a second bend portion that is bent with respect to the first extension portion, and a second extension portion that extends from the second bend portion.

According to the vehicle visual recognition device of the third aspect of the present disclosure, the covering member is bent with respect to the first extension portion at the second bend portion that is joined to the first extension portion, and the second extension portion extends from the second bend portion. This thereby enables the reinforcing member to be further reinforced.

A vehicle visual recognition device of a fourth aspect of the present disclosure is the vehicle visual recognition device of the third aspect, wherein the reinforcing section is provided at a portion of the covering member that includes the second bend portion, and is joined to both the first extension portion and the second extension portion.

According to the vehicle visual recognition device of the fourth aspect of the present disclosure, the reinforcing section is provided at the portion of the covering member including the second bend portion, and is joined to the covering section and the second extension portion. This thereby enables the covering member to be reinforced at the second bend portion and at portions in the vicinity thereof.

A vehicle visual recognition device of a fifth aspect of the present disclosure is the vehicle visual recognition device of the third aspect or the fourth aspect, wherein the second extension portion is provided on the opposite side of the first extension portion from the covering section, and the reinforcing section is provided so as to join together a covering section side end and a second extension portion side end of the first extension portion.

According to the vehicle visual recognition device of the fifth aspect of the present disclosure, the reinforcing section is provided so as to join together the covering section side end and the second extension portion side end on the opposite side to the covering side end of the first extension portion of the covering member. This thereby enables the rigidity of the covering member with respect to bending load attempting to cause bending deformation of the first extension portion to be raised.

A vehicle visual recognition device of the sixth aspect of the present disclosure is the vehicle visual recognition device of any one of the third aspect to the fifth aspect, wherein reinforcing sections are provided on both sides of the first extension portion.

According to the vehicle visual recognition device of the sixth aspect of the present disclosure, the reinforcing sections are provided on both sides of the first extension portion of the covering member, such that the first extension portion is reinforced from both sides by the reinforcing sections. This thereby enables the rigidity of the covering member with respect to bending load attempting to cause bending deformation of the first extension portion to be raised.

A vehicle visual recognition device of a seventh aspect of the present disclosure is the vehicle visual recognition device of the sixth aspect, wherein the reinforcing section provided on one side of the first extension portion is provided opposing the reinforcing section provided on the other side of the first extension portion.

According to the vehicle visual recognition device of the seventh aspect of the present disclosure, the reinforcing section provided on the one side of the first extension portion is provided opposing the reinforcing section provided on the other side of the first extension portion, thereby enabling the cross-section area of a portion of the first extension portion provided with the reinforcing section to be made larger. This thereby enables the rigidity of the covering member with respect to bending load attempting to cause bending deformation of the first extension portion to be raised.

A vehicle visual recognition device of an eighth aspect of the present disclosure is the vehicle visual recognition device of any one of the first aspect to the seventh aspect, further including an electrical connection section that is provided at the covering member and that is electrically connected to the operating mechanism, the reinforcing section being provided beside a placement position of the electrical connection section on the first extension portion.

According to the vehicle visual recognition device of the eighth aspect of the present disclosure, the electrical connection section is provided at the covering member and is electrically connected to the operating mechanism, and the reinforcing section is provided beside the placement position of the electrical connection section on the first extension portion of the covering member. This thereby enables the mechanical strength of the first extension portion of the covering member to be raised at the placement position of the electrical connection section.

A vehicle visual recognition device of a ninth aspect of the present disclosure is the vehicle visual recognition device of the eighth aspect, further including plural electrical connection sections, the reinforcing section being provided between the plural electrical connection sections.

According to the vehicle visual recognition device of the ninth aspect of the present disclosure, providing the reinforcing section between the plural electrical connection sections enables foreign matter or the like to be suppressed from forming an electrical join between the plural electrical connection sections.

### Advantageous Effects of the Invention

As described above, the vehicle visual recognition device according to the present invention is capable of improving ease of assembly, and is also capable of reinforcing the covering member.

### BRIEF DESCRIPTION OF DRAWINGS

FIG. 1 is an exploded perspective view of a vehicle door mirror device according to an exemplary embodiment of the present invention, as viewed from a vehicle front side and vehicle width direction inside.

FIG. 2 is a cross-section of relevant portions of a vehicle door mirror device according to an exemplary embodiment of the present invention, as viewed from a vehicle width direction outside.

FIG. 3 is a perspective view of a visor body of a vehicle door mirror device according to an exemplary embodiment of the present invention, as viewed from a vehicle rear side and vehicle width direction inside.

FIG. 4 is a perspective view illustrating reinforcement, a turn lamp, and a lighting lamp of a vehicle door mirror device according to an exemplary embodiment of the present invention, as viewed from the vehicle front side and upper side.

FIG. 5 is a perspective view illustrating reinforcement of a vehicle door mirror device according to an exemplary embodiment of the present invention, as viewed from the vehicle front side and vehicle width direction outside.

FIG. 6 is a perspective view illustrating reinforcement of a vehicle door mirror device according to an exemplary embodiment of the present invention, as viewed from the vehicle rear side and vehicle width direction inside.

### DESCRIPTION OF EMBODIMENTS

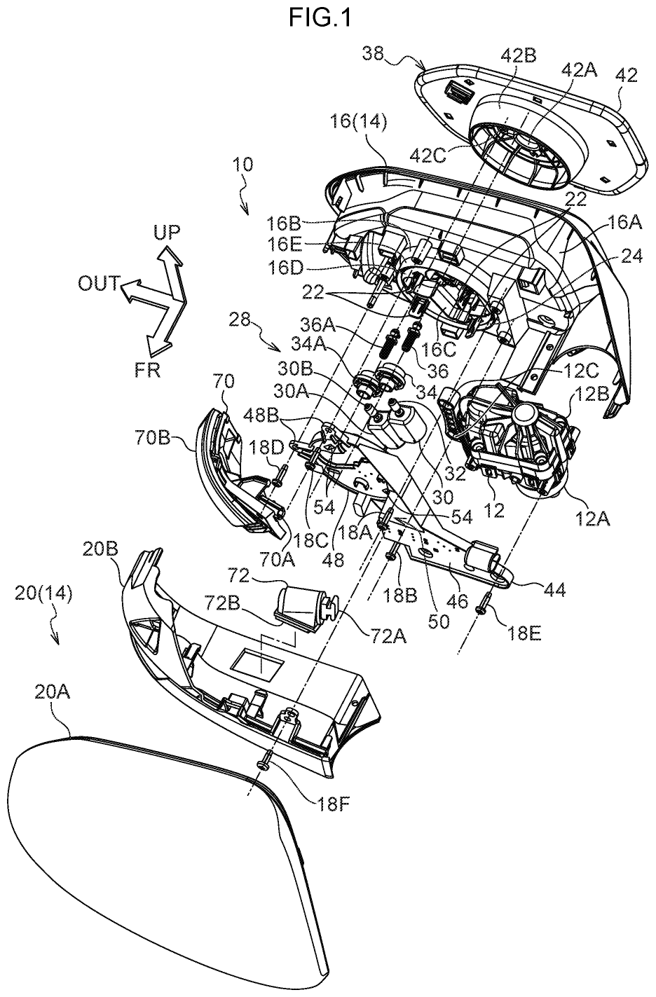

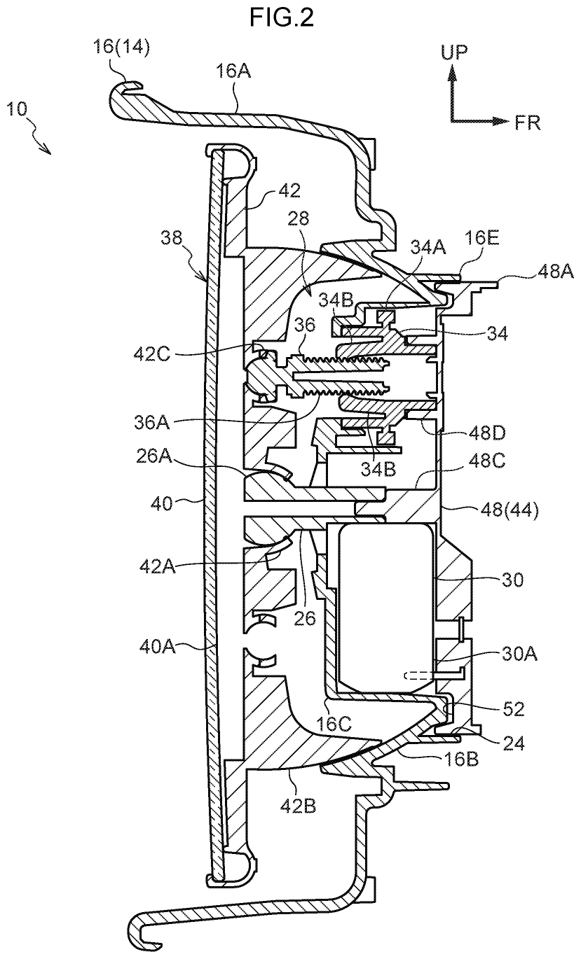

FIG. 1 is an exploded perspective view of a vehicle door mirror device 10, serving as a vehicle visual recognition device according to an exemplary embodiment of the present invention, as viewed from a vehicle front side and vehicle width direction inside (vehicle left side). FIG. 2 is a cross-section of relevant portions of the vehicle door mirror device 10, as viewed from a vehicle width direction outside (vehicle right side). Note that in the drawings, the arrow FR indicates the vehicle front, the arrow OUT indicates a vehicle width direction outside, and the arrow UP indicates upward.

The vehicle door mirror device 10 according to the present exemplary embodiment is supported at the outside of a door (a front side door, a vehicle body side) of a vehicle.

As illustrated in FIG. 1, the vehicle door mirror device 10 includes a stowing mechanism 12. The stowing mechanism 12 is provided with a stand 12A, serving as a support member. The vehicle door mirror device 10 is supported on the door by the stand 12A being supported at a vehicle front side end of an up-down direction intermediate portion of the door. A swing body 12B is supported by the stand 12A. The swing body 12B is swung about the up-down direction with respect to the stand 12A by electrical operation of the stowing mechanism 12. The swing body 12B is electrically connected, through the inside of the stand 12A, to a controller (not illustrated in the drawings) on the vehicle body side, and the stowing mechanism 12 is electrically operated under the control of the controller.

A pair of circular column shaped fitting recesses 12C, each serving as a fitted portion, are provided at a vehicle width direction inside end portion of the swing body 12B. The pair of fitting recesses 12C are disposed alongside each other in the up-down direction. The fitting recesses 12C are open toward the vehicle front side. A bottom wall (not illustrated in the drawings) of each of the fitting recesses 12C is formed in an annular plate shape (or a circular cylinder shape), and a central portion thereof is open toward both vehicle front-rear direction sides.

A visor 14, made from resin and serving as an outer peripheral body, is supported on the swing body 12B of the stowing mechanism 12. The visor 14 is provided with a visor body 16, serving as a housing body. The swing body 12B is fixed to a vehicle front side of a vehicle width direction inside end portion of the visor body 16, for example by fastening with a first screw 18A and a second screw 18B, serving as assembly members. The first screw 18A fixes the fitting recess 12C at the upper side of the swing body 12B to the visor body 16, and the second screw 18B fixes the fitting recess 12C at the lower side of the swing body 12B to the visor body 16. A curved plate shaped visor cover 20, serving as a covering member, is assembled at the vehicle front side of the visor body 16 such that reinforcement 44, serving as a covering member, described later, is sandwiched between the visor cover 20 and the visor body 16. An outer periphery of the visor cover 20 is fitted to an outer periphery of the visor body 16, so that the visor cover 20 covers the vehicle front side of the visor body 16. An upper cover 20A is provided at the upper side of the visor cover 20, and a lower cover 20B is provided at the lower side of the visor cover 20. The visor cover 20 is configured by combining the upper cover 20A and the lower cover 20B.

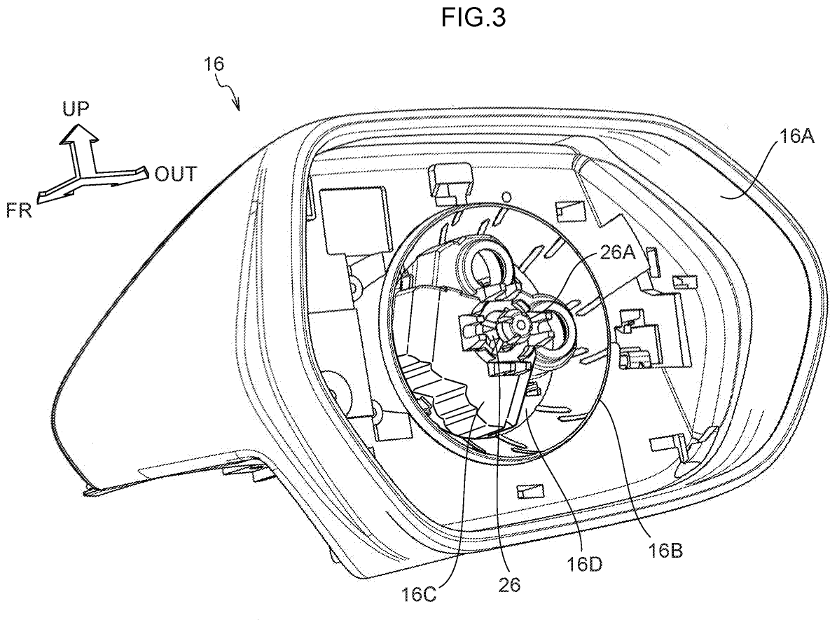

As illustrated in FIG. 1 to FIG. 3, a substantially cuboid box-shaped housing wall 16A, serving as a housing section, is provided to the visor body 16. The inside of the housing wall 16A is open toward the vehicle rear side.

A support wall 16B (a case lower portion), serving as a support section, is integrally provided to a vehicle front side wall (a bottom wall) of the housing wall 16A. The support wall 16B projects to the vehicle front side and vehicle rear side of the vehicle front side wall of the housing wall 16A. The support wall 16B is substantially tube shaped, and is disposed such that a center axis line of the support wall 16B is parallel to the vehicle front-rear direction. The support wall 16B has a spherical wall profile, and an internal diameter dimension of the support wall 16B gradually increases on progression toward the vehicle rear.

A receptacle shaped covering wall 16C (a case upper portion), serving as a covering section, is provided to the inside of the support wall 16B. The entire periphery of a vehicle front side end of the covering wall 16C is integrated together with the entire periphery of a vehicle front side end of the support wall 16B. A flat plate shaped coupling wall 16D is integrally provided between the vehicle front side end of the covering wall 16C and the vehicle front side end of the support wall 16B. The coupling wall 16D couples together the vehicle front side end of the covering wall 16C and the vehicle front side end of the support wall 16B at positions where the vehicle front side end of the covering wall 16C and the vehicle front side end of the support wall 16B are not directly integrated together. The inside of the covering wall 16C is open toward the vehicle front side of the support wall 16B. The inside of the covering wall 16C is thereby open toward the vehicle front side of the housing wall 16A.

A predetermined number (four in the present exemplary embodiment) of rectangular plate shaped limiting plates 22, serving as limiting portions, are integrally provided to the coupling wall 16D. The limiting plates 22 project from the coupling wall 16D toward the vehicle front side. The predetermined number of limiting plates 22 are arranged at substantially uniform spacings around the circumferential direction of the support wall 16B. The limiting plates 22 are disposed so as to intersect the radial direction of the support wall 16B.

A circular cylindrical shaped fitting cylinder 16E, serving as a perimeter portion, is integrally provided to a vehicle front-rear direction intermediate portion of an outer peripheral face of the support wall 16B. The fitting cylinder 16E projects from the support wall 16B toward the vehicle front side, and is disposed coaxially to the support wall 16B. An outer recess 24 with a substantially trapezoidal shaped cross-section profile, serving as a recess, is formed between a vehicle front side portion of the support wall 16B and the fitting cylinder 16E. The outer recess 24 is open toward the vehicle front side.

A substantially circular cylinder shaped retention cylinder 26, serving as a central support section (a retention section), is integrally provided to a vehicle rear side wall (a bottom wall) of the covering wall 16C. The retention cylinder 26 projects to the vehicle front side and the vehicle rear side of the vehicle rear side wall of the covering wall 16C, and is disposed coaxially to the support wall 16B. A substantially spherical shaped retention ball 26A is provided at a vehicle rear side end portion of the retention cylinder 26. Peripheral faces of a vehicle front side portion and a vehicle rear side portion of the retention ball 26A have a spherical face profile, and the center of the spherical face profile is aligned with the center of an inner peripheral face of the support wall 16B.

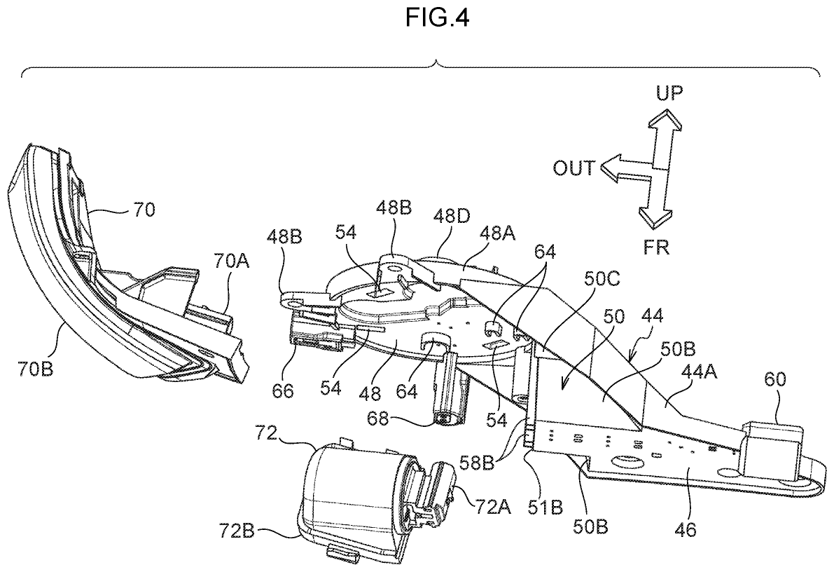

The elongated plate shaped reinforcement 44 (see FIG. 4 to FIG. 6), serving as a reinforcing body (a rigid member) and made substantially from resin, is provided at the vehicle front side of the visor body 16 and the swing body 12B of the stowing mechanism 12. A substantially triangular plate shaped reinforcing plate 46, serving as a reinforcing section or a second extension portion, is integrally provided to a vehicle width direction inside portion of the reinforcement 44. A substantially circular plate shaped bottom wall portion 48, serving as a blocking section or a covering section, is provided at a vehicle width direction outside portion of the reinforcement 44. A linking wall 50, serving as a first extension portion, is provided at a vehicle width direction intermediate portion of the reinforcement 44.

The linking wall 50 includes a central wall portion 50A. The central wall portion 50A is provided at a vehicle up-down direction intermediate portion of the reinforcement 44. A thickness direction of the central wall portion 50A runs in the vehicle width direction. An upper wall portion 50B is disposed at the vehicle upper side of the central wall portion 50A. A vehicle width direction outside end of the upper wall portion 50B is joined to a vehicle upper side end of the central wall portion 50A. The upper wall portion 50B extends toward the vehicle width direction inside from the vehicle upper side end of the central wall portion 50A.

An upper zigzag wall portion 50C is disposed at the vehicle upper side of the upper wall portion 50B of the linking wall 50. The length direction of the upper zigzag wall portion 50C runs principally along the vehicle width direction. At an inside bend portion on one length direction side (a vehicle width direction inside) portion of the upper zigzag wall portion 50C, the upper zigzag wall portion 50C is bent about an axis having an axial direction extending toward the vehicle up-down direction sides. On the one length direction side of the inside bend portion of the upper zigzag wall portion 50C, the upper zigzag wall portion 50C extends in a direction inclined toward the vehicle front side and the vehicle width direction inside. At an outside bend portion on another length direction side (a vehicle width direction outside) portion of the upper zigzag wall portion 50C, the upper zigzag wall portion 50C is also bent about an axis having an axial direction extending toward the vehicle up-down direction sides. On the other length direction side of the outside bend portion of the upper zigzag wall portion 50C, the upper zigzag wall portion 50C extends toward the vehicle rear side.

A lower wall portion 50D is disposed at the vehicle lower side of the central wall portion 50A of the linking wall 50. A vehicle width direction outside end of the lower wall portion 50D is joined to a vehicle lower side end of the central wall portion 50A. The lower wall portion 50D extends toward the vehicle width direction inside from the vehicle lower side end of the central wall portion 50A.

A lower zigzag wall portion 50E is disposed at the vehicle lower side of the lower wall portion 50D of the linking wall 50. The length direction of the lower zigzag wall portion 50E runs principally along the vehicle width direction. At an inside bend portion on one length direction side (a vehicle width direction inside) portion of the lower zigzag wall portion 50E, the lower zigzag wall portion 50E is bent about an axis having an axial direction extending toward the vehicle up-down direction sides. On the one length direction side of the inside bend portion of the lower zigzag wall portion 50E, the lower zigzag wall portion 50E extends toward the vehicle front side. At an outside bend portion on another length direction side (vehicle width direction outside) portion of the lower zigzag wall portion 50E, the lower zigzag wall portion 50E is also bent about an axis having an axial direction extending toward the vehicle up-down direction sides. On the other length direction side of the outside bend portion of the lower zigzag wall portion 50E, the lower zigzag wall portion 50E extends toward the vehicle rear side.

A vehicle rear side end of the linking wall 50 of the reinforcement 44 configures a first bend portion 51A. The first bend portion 51A is joined to a vehicle width direction inside end of the bottom wall portion 48 of the reinforcement 44. Thus, the linking wall 50 extends toward the vehicle front side from the first bend portion 51A as viewed from the bottom wall portion 48. A vehicle front side end of the linking wall 50 configures a second bend portion 51B. The second bend portion 51B is joined to a vehicle width direction outside end of the reinforcing plate 46 of the reinforcement 44. Thus, the reinforcing plate 46 extends toward the vehicle width direction inside from the second bend portion 51B as viewed from the linking wall 50. The bottom wall portion 48 and the reinforcing plate 46 of the reinforcement 44 are joined together by the linking wall 50, such that the bottom wall portion 48 is disposed at the vehicle rear side with respect to the reinforcing plate 46.

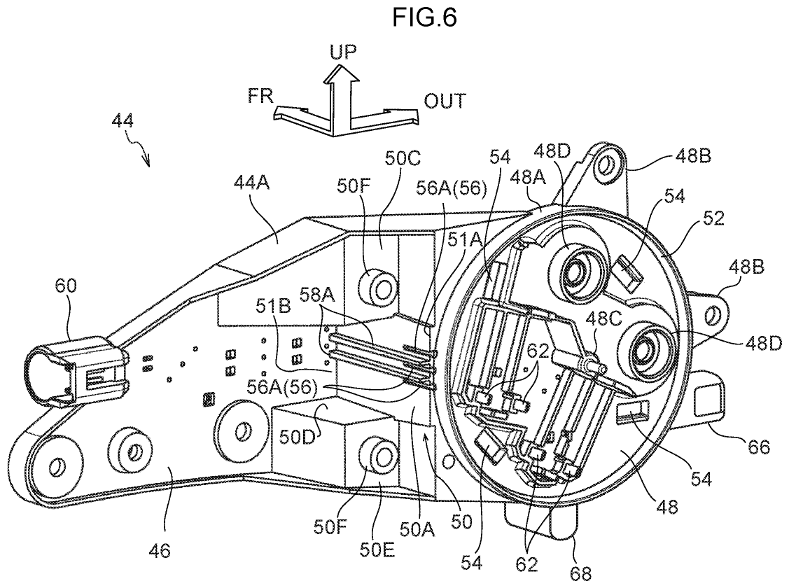

An elongated plate shaped reinforcing peripheral wall 44A is provided to peripheral portions of the reinforcement 44 at portions corresponding to the reinforcing plate 46 and the linking wall 50. The width direction of the reinforcing peripheral wall 44A extends along the vehicle front-rear direction. A vehicle front-rear direction intermediate portion of the reinforcing peripheral wall 44A is joined to portions of the reinforcing plate 46 and the linking wall 50 at the peripheral portions of the reinforcement 44. This raises the rigidity at portions of the reinforcement 44 where the reinforcing plate 46 and the linking wall 50 are disposed. A circular cylinder shaped circumferential fitting wall 48A is provided around the entire circumference of the bottom wall portion 48 of the reinforcement 44. The circumferential fitting wall 48A is disposed perpendicular to an inside portion of the bottom wall portion 48 and projects toward both vehicle front-rear direction sides, thereby increasing the rigidity of the bottom wall portion 48. Circular cylinder shaped fitting projections 50F (see FIG. 6), serving as fitting portions, are respectively provided to the upper zigzag wall portion 50C and the lower zigzag wall portion 50E of the linking wall 50 of the reinforcement 44. Each of the fitting projections 50F projects toward the vehicle rear side, and an inner portion thereof is open toward both vehicle front-rear direction sides.

The upper zigzag wall portion 50C and the lower zigzag wall portion 50E of the reinforcement 44 are respectively fixed to the visor body 16 together with the swing body 12B of the stowing mechanism 12 by fastening with the first screw 18A and the second screw 18B. The first screw 18A passes through the inside of the fitting projection 50F of the upper zigzag wall portion 50C and the inside of the bottom wall of the fitting recess 12C at the upper side of the swing body 12B. This fitting projection 50F is fitted inside the corresponding fitting recess 12C, and the bottom wall of the corresponding fitting recess 12C is clamped between this fitting projection 50F and the visor body 16. The second screw 18B passes through the inside of the fitting projection 50F of the lower zigzag wall portion 50E and the inside of the bottom wall of the fitting recess 12C at the lower side of the swing body 12B. This fitting projection 50F is fitted inside the corresponding fitting recess 12C, and the bottom wall of the corresponding fitting recess 12C is clamped between this fitting projection 50F and the visor body 16.

A pair of triangular plate shaped assembly plates 48B, serving as assembly portions, are integrally provided to vehicle width direction outside portions of the bottom wall portion 48 of the reinforcement 44. The pair of assembly plates 48B project from the bottom wall portion 48 toward the upper side and the vehicle width direction outside respectively. The reinforcement 44 is fixed to the visor body 16 at the pair of assembly plates 48B by fastening with a third screw 18C and a fourth screw 18D, serving as assembly members. A vehicle width direction inside end portion of the reinforcing plate 46 of the reinforcement 44 is fixed to the swing body 12B of the stowing mechanism 12 by fastening with a fifth screw 18E, serving as an assembly member.

The reinforcement 44 has higher rigidity than the visor body 16, and the reinforcement 44 reinforces the visor body 16 and the swing body 12B. Moreover, the visor cover 20 (the lower cover 20B) of the visor 14 is fixed to the reinforcement 44 by fastening with a sixth screw 18F, serving as a fixing member. The visor cover 20 is thereby assembled to the visor body 16 with the reinforcement 44 sandwiched therebetween, as described above.

An inner recess 52 (see FIG. 2 and FIG. 6), serving as a recess with a rectangular cross-section profile, is formed about the entire circumference of a vehicle rear side face of the bottom wall portion 48. The inner recess 52 is disposed at the radial direction inside of the circumferential fitting wall 48A of the bottom wall portion 48. A vehicle rear side portion of the circumferential fitting wall 48A is inserted into the outer recess 24 of the visor body 16, and a vehicle front side end of the support wall 16B of the visor body 16 is inserted into the inner recess 52. An outer peripheral face of the circumferential fitting wall 48A is fitted into the fitting cylinder 16E of the visor body 16, such that the outer peripheral face of the support wall 16B fits together with an outer peripheral face of the inner recess 52 (an inner peripheral face of the circumferential fitting wall 48A). Thus, the bottom wall portion 48 covers and closes off the support wall 16B, the covering wall 16C, and the coupling wall 16D of the visor body 16 from the vehicle front side, and reinforces the support wall 16B, the covering wall 16C, and the coupling wall 16D.

A predetermined number (four in the present exemplary embodiment) of rectangular shaped limiting holes 54, serving as limiting portions, are formed piercing through the bottom wall portion 48. The predetermined number of limiting holes 54 are arranged at substantially uniform spacings around the circumferential direction of the bottom wall portion 48. Each of the limiting holes 54 is disposed so as to intersect a radial direction of the bottom wall portion 48. The limiting plates 22 of the visor body 16 are inserted (fitted) into the limiting holes 54. Movement of the bottom wall portion 48 in the circumferential direction and the radial direction with respect to the visor body 16 is thereby limited.

A substantially circular column shaped fit-insertion column 48C, serving as a fit-insertion portion, is integrally provided at a central portion of the bottom wall portion 48. The fit-insertion column 48C projects from the bottom wall portion 48 toward the vehicle rear side, and is disposed coaxially to the bottom wall portion 48. A leading end portion of the fit-insertion column 48C has a reduced diameter. The leading end portion of the fit-insertion column 48C is fit-inserted inside the retention cylinder 26 of the visor body 16 from the vehicle front side, thereby reinforcing the retention cylinder 26.

Circular cylinder shaped support cylinders 48D are integrally provided to an upper portion and a vehicle width direction outside portion of the bottom wall portion 48, at the inside of the respective assembly plates 48B in the radial direction of the bottom wall portion 48. Each of the support cylinders 24E projects from the bottom wall portion 48 toward the vehicle rear side, and is disposed with a center axis line parallel to the center axis line of the bottom wall portion 48.

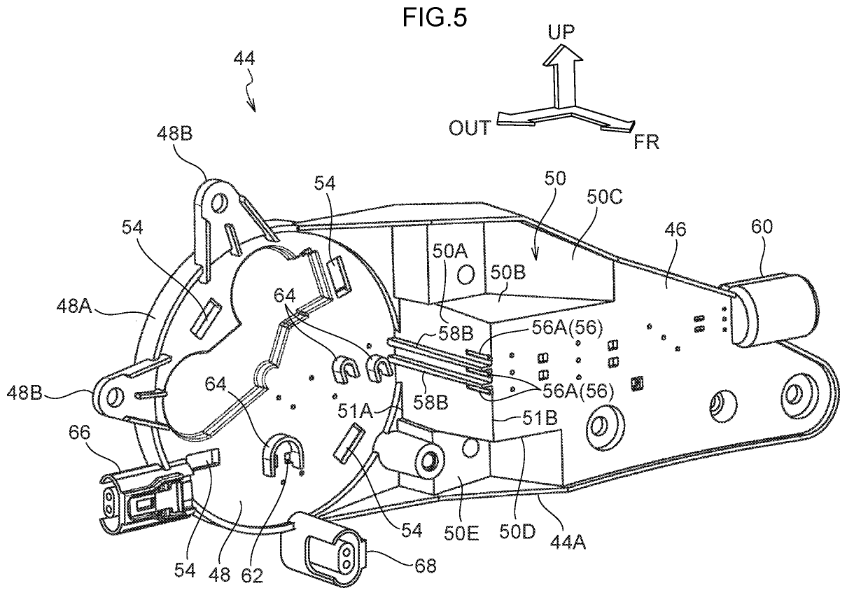

Plural, narrow elongated belt shaped conductor lines 56 (see FIG. 5 and FIG. 6), serving as electrical connection sections and configuring wiring, are integrally provided to the reinforcement 44 by insert molding. The conductor lines 56 extend across the central wall portion 50A of the linking wall 50 of the reinforcement 44 to the bottom wall portion 48 in a state in which the conductor lines 56 are substantially entirely disposed within the reinforcement 44. The plural conductor lines 56 are exposed through the central wall portion 50A at a vehicle front side end portion and a vehicle rear side end portion of the central wall portion 50A of the linking wall 50 (these exposed portions of the conductor lines 56 are hereafter referred to as “exposed portions 56A”). The exposed portions 56A at the vehicle front side are exposed at the vehicle width direction outside of the central wall portion 50A in a state extending along the vehicle front-rear direction, and the exposed portions 56A at the vehicle rear side are exposed at the vehicle width direction inside of the central wall portion 50A in a state extending along the vehicle front-rear direction.

A predetermined number of elongated plate shaped partitioning walls 58A, serving as a suppressing section or a reinforcing section, are integrally provided to a vehicle width direction inside face of the central wall portion 50A of the linking wall 50 of the reinforcement 44. A predetermined number of elongated plate shaped partitioning walls 58B, serving as a suppressing section or a reinforcing section, are integrally provided to a vehicle width direction outside face of a vehicle width direction outside wall portion of the central wall portion 50A.

The partitioning walls 58A of the central wall portion 50A of the linking wall 50 project toward the vehicle width direction inside from the vehicle width direction inside face of the vehicle width direction outside wall portion of the central wall portion 50A. A vehicle front side end, this being one length direction side end, of each of the partitioning walls 58A, is joined to a vehicle rear side face of the reinforcing plate 46, and a vehicle rear side end, this being another length direction side end of each of the partitioning walls 58A, is in the same plane as a vehicle rear side face of a vehicle width direction inside portion of the bottom wall portion 48 of the reinforcement 44.

On the other hand, the partitioning walls 58B of the central wall portion 50A of the linking wall 50 project toward the vehicle width direction outside from the vehicle width direction outside face of the vehicle width direction outside wall portion of the central wall portion 50A. A vehicle front side end, this being one length direction side end of each of the partitioning walls 58B, is in the same plane as a vehicle front side face of a vehicle width direction outside portion of the reinforcing plate 46, and a vehicle rear side end, this being another length direction side end of each of the partitioning walls 58B, is joined to a vehicle front side face of the bottom wall portion 48 of the reinforcement 44. The partitioning walls 58A, 58B are disposed between the exposed portions 56A of the conductor lines 56 so as to follow the conductor lines 56, and are provided opposing each other along the vehicle width direction across the central wall portion 50A.

A main connector 60 (bracket), serving as a receiver portion, is integrally provided to the reinforcing plate 46. The main connector 60 is electrically connected to each of the conductor lines 56, and is also electrically connected to the controller through the inside of the swing body 12B and the inside of the stand 12A of the stowing mechanism 12.

Terminal 62 pairs (see FIG. 6), configuring wiring, are respectively provided at a lower portion and at a vehicle width direction inside portion of the bottom wall portion 48 by insert molding. The terminals 62 project toward the vehicle rear side from the bottom wall portion 48, and are exposed at the vehicle rear side and the vehicle front side of the bottom wall portion 48.

Suppressing walls 64 (see FIG. 4 and FIG. 5), each having an inverted U-shaped plate shaped cross-section profile and serving as a suppressing section, are integrally provided to a lower portion and a vehicle width direction inside portion of a vehicle front side face of the bottom wall portion 48. The suppressing walls 64 project toward the vehicle front side from the bottom wall portion 48, and cover the upper side and both vehicle width direction sides of portions of the respective terminals 62 exposed through the bottom wall portion 48.

A first output connector 66 (see FIG. 4 to FIG. 6), serving as a supply portion, is integrally provided to a vehicle width direction outside portion of the bottom wall portion 48. The first output connector 66 is electrically connected to the pair of conductor lines 56, and projects toward the vehicle width direction outside from the bottom wall portion 48.

A second output connector 68 (see FIG. 4 to FIG. 6), serving as a supply portion, is integrally provided to a lower end of the bottom wall portion 48. The second output connector 68 is electrically connected to the pair of conductor lines 56 and projects toward the vehicle front side from the bottom wall portion 48.

A mirror face adjustment mechanism 28, serving as an operating mechanism, is retained between the covering wall 16C of the visor body 16 and the bottom wall portion 48 of the reinforcement 44.

Motors 30, each serving as a drive section, are provided to the mirror face adjustment mechanism 28 at respective positions corresponding to a lower portion and a vehicle width direction inside portion of the bottom wall portion 48. A main body 30A of each of the motors 30 is retained in a state clamped between the covering wall 16C and the bottom wall portion 48. An output shaft 30B extends from each of the main bodies 30A, and a worm 32, serving as an output member, is fixed to each of the output shafts 30B. The terminal 62 pairs of the reinforcement 44 are electrically connected to the respective main bodies 30A. Electrical power is supplied to the motors 30 and the motors 30 are driven under the control of the controller to electrically operate the mirror face adjustment mechanism 28.

A pair of substantially circular cylinder shaped wheel drives 34 made from resin and serving as transmission members are provided to the mirror face adjustment mechanism 28. In a state in which a vehicle front side portion of each of the wheel drives 34 has been fit-inserted into the support cylinders 48D of the bottom wall portion 48, the wheel drives 34 are clamped between the covering wall 16C and the bottom wall portion 48 and retained so as to be rotatable about their axes.

A worm wheel 34A is formed coaxially to an outer peripheral portion at an axial direction (vehicle front-rear direction) intermediate portion of each of the wheel drives 34. The worm wheel 34A is meshed (engaged) with the worm 32 of the corresponding motor 30. Thus, the worm wheel 34A is rotated by driving the motor 30 so as to rotate the worm 32 and to rotate the wheel drive 34.

A predetermined number (four in the present exemplary embodiment) of meshing claws 34B, serving as engaging portions, are formed to an inner peripheral portion of each of the wheel drives 34 at the vehicle rear side of the worm wheel 34A. The predetermined number of meshing claws 34B are disposed at uniform spacings around the circumferential direction of the wheel drives 34. The meshing claws 34B extend toward the vehicle rear side and are elastic. Leading ends (vehicle rear side ends) of the meshing claws 34B project toward the radial direction inside of the respective wheel drives 34.

A substantially circular column shaped rod drive 36, serving as a moving member, is coaxially inserted inside each of the wheel drives 34. The rod drives 36 project through the covering wall 16C toward the vehicle rear side. One of the rod drives 36 is disposed above (or alternatively below) the center axis line of the support wall 16B of the visor body 16. The other of the rod drives 36 is disposed at the vehicle width direction outside (or alternatively at the vehicle width direction inside) of the center axis line of the support wall 16B.

Each of the rod drives 36 is configured with a thread 36A at portions other than a leading end portion (a vehicle rear side end portion). The leading ends of the meshing claws 34B of the wheel drives 34 are meshed (engaged) with the corresponding threads 36A. The leading end portion of each of the rod drives 36 has a substantially spherical shape.

A mirror body 38, serving as a visual recognition section, is housed inside the housing wall 16A of the visor body 16. The entire periphery and vehicle front side of the mirror body 38 are covered by the housing wall 16A.

A substantially rectangular plate shaped mirror 40, serving as a visual recognition section, is provided at a vehicle rear side portion of the mirror body 38. The surface of the mirror 40 is exposed at the vehicle rear side of the visor body 16. A mirror face 40A (the surface of a reflective layer on a reverse side) of the mirror 40 faces toward the vehicle rear side. The mirror 40 assists an occupant (in particular the driver) of the vehicle with visual recognition rearward of the vehicle.

A substantially rectangular plate shaped mirror holder 42, made from resin and serving as a sliding body, is provided at a vehicle front side portion of the mirror body 38. The entire periphery of the mirror 40 is fixed (retained) around the entire periphery of the mirror holder 42, and the mirror holder 42 covers the vehicle front side (the reverse side) of the mirror 40.

A substantially tube shaped attachment wall 42A, serving as an attachment portion, is formed to the mirror holder 42 at the vehicle front side of a central position (center of gravity position) of the mirror 40. The attachment wall 42A is disposed coaxially to the support wall 16B of the visor body 16. The attachment wall 42A has a substantially spherical wall profile, and the inner diameter dimension of the attachment wall 42A gradually increases on progression toward the vehicle rear. The retention ball 26A of the retention cylinder 26 of the visor body 16 is fit-inserted into the attachment wall 42A. The attachment wall 42A is thereby retained on the retention ball 26A so as to be capable of tilting and sliding.

A substantially tube shaped sliding wall 42B, serving as a sliding portion, is integrally provided at the vehicle front side of the mirror holder 42. The sliding wall 42B is disposed coaxially to the support wall 16B of the visor body 16. The sliding wall 42B has a spherical wall profile, and the external diameter dimension of the sliding wall 42B gradually increases on progression toward the vehicle rear. An outer peripheral face of the sliding wall 42B abuts the inner peripheral face of the support wall 16B, and the sliding wall 42B is supported by an inner peripheral face of the support wall 16B so as to be capable of tilting and sliding.

The mirror holder 42 is formed with a pair of substantially tube shaped swivel walls 42C, serving as swivel portions, at a radial direction inside of the sliding wall 42B. One of the swivel walls 42C is disposed above (or alternatively below) the center axis line of the support wall 16B of the visor body 16. The other of the swivel walls 42C is disposed at the vehicle width direction outside (or alternatively at the vehicle width direction inside) of the center axis line of the support wall 16B. The swivel walls 42C are disposed with the center axis lines thereof parallel to the center axis line of the support wall 16B of the visor body 16. The swivel walls 42C each have a substantially spherical wall profile, and the inner diameter dimension of the swivel walls 42C gradually increases on progression from the two vehicle front-rear direction end sides of the swivel walls 42C toward the vehicle front-rear direction center thereof.

The leading end portions of the rod drives 36 of the mirror face adjustment mechanism 28 are fit-inserted into and retained by the corresponding swivel walls 42C. The swivel walls 42C permit swiveling with respect to the leading end portions of the respective rod drives 36, but rotation about the axes of the rod drives 36 is restricted. Thus, as stated above, in the mirror face adjustment mechanism 28, as the wheel drives 34 (including the meshing claws 34B) are rotated, the meshing position of the leading ends of the meshing claws 34B with the threads 36A of the respective rod drives 36 is displaced, such that the respective rod drives 36 are moved (slide) in the vehicle front-rear direction (axial direction).

A turn lamp 70 (see FIG. 4), serving as an electrical mechanism, is retained between a vehicle width direction outside portion of the lower cover 20B of the visor cover 20 and the visor body 16. A first input connector 70A is integrally provided to a vehicle width direction inside end portion of the turn lamp 70. The first input connector 70A is mounted to the first output connector 66 of the reinforcement 44, such that the turn lamp 70 is retained by the reinforcement 44. The first input connector 70A is electrically connected to the first output connector 66. Electrical power is supplied to the turn lamp 70 and the turn lamp 70 is electrically operated under the control of the controller. An illumination portion 70B, serving as a radiating portion, is provided to a vehicle front side portion of the turn lamp 70. The illumination portion 70B is exposed at the exterior of the lower cover 20B. Thus, by electrically operating the turn lamp 70, light is shone (radiated) toward the vehicle width direction outside and vehicle front side from the illumination portion 70B.

A lighting lamp 72 (see FIG. 4), serving as an electrical mechanism, is retained at an upper side of a vehicle width direction intermediate portion of the lower cover 20B. A second input connector 72A is integrally provided to a vehicle width direction inside end portion of the lighting lamp 72. The second input connector 72A is mounted to the second output connector 68 of the reinforcement 44, and the lighting lamp 72 is thereby retained by the reinforcement 44. The second input connector 72A is electrically connected to the second output connector 68. Electrical power is supplied to the lighting lamp 72 and the lighting lamp 72 is electrically operated under the control of the controller. A lighting portion 72B, serving as a radiating portion, is provided at a lower end portion of the lighting lamp 72. The lighting portion 72B is exposed at the exterior of the lower cover 20B. Thus, by electrically operating the lighting lamp 72, light is shone (radiated) toward the lower side from the lighting portion 72B.

Next, explanation follows regarding operation of the present exemplary embodiment.

In the vehicle door mirror device 10 configured as described above, the swing body 12B swings with respect to the stand 12A by electrical operation of the stowing mechanism 12, and the mirror body 38 (including the visor 14 (the visor body 16 and the visor cover 20), the reinforcement 44, the mirror face adjustment mechanism 28, the turn lamp 70, and the lighting lamp 72) swing as a unit with the swing body 12B. The mirror body 38 thereby swings toward the vehicle rear side and the vehicle width direction inside, such that the mirror body 38 is stowed. Moreover, the mirror body 38 is flipped out (deployed, returned) by the mirror body 38 being swung toward the vehicle front side and the vehicle width direction outside.

Moreover, when the motors 30 are driven by electrical operation of the mirror face adjustment mechanism 28 so as to rotate the worms 32, the wheel drives 34 are rotated, and the rod drives 36 are moved in the vehicle front-rear direction. Thus, by tilting the mirror body 38 (the mirror 40 and the mirror holder 42) in at least one out of the up-down direction or the vehicle width direction using the rod drives 36, the angle of the mirror face 40A of the mirror 40 (i.e. the direction in which the occupant is assisted with visual recognition by the mirror 40) is adjusted in the at least one out of the up-down direction or the vehicle width direction. Moreover, when tilting the mirror body 38, the attachment wall 42A of the mirror body 38 slides against, while being retained (supported) by, the retention ball 26A of the retention cylinder 26 of the visor body 16, and the sliding wall 42B of the mirror body 38 slides against, while being supported by, the support wall 16B of the visor body 16.

Furthermore, by electrical operation of the turn lamp 70, light is shone toward the vehicle width direction outside and vehicle front side from the illumination portion 70B of the turn lamp 70. By electrical operation of the lighting lamp 72, light is shone toward the lower side from the lighting portion 72B of the lighting lamp 72.

In order to assemble the vehicle door mirror device 10, the visor body 16 is moved toward the mirror body 38 from the vehicle front side to house the mirror body 38 inside the housing wall 16A of the visor body 16. The retention ball 26A of the visor body 16 is fit-inserted into the attachment wall 42A of the mirror holder 42 from the vehicle front side when this is performed.

The stowing mechanism 12 is assembled to (disposed on) the visor body 16 from the vehicle front side.

The mirror face adjustment mechanism 28 (the motor 30, the worms 32, the wheel drives 34, and the rod drives 36) is also assembled to (disposed on) the covering wall 16C of the visor body 16 from the vehicle front side. The leading end portions of the rod drives 36 are fit-inserted into the swivel walls 42C of the mirror holder 42 from the vehicle front side when this is performed.

Next, the reinforcement 44 is assembled to the swing body 12B and the visor body 16 from the vehicle front side using the first screw 18A, the second screw 18B, the third screw 18C, the fourth screw 18D, and the fifth screw 18E. The leading end portion of the fit-insertion column 48C of the reinforcement 44 (the bottom wall portion 48) is fit-inserted into the retention cylinder 26 of the visor body 16 from the vehicle front side, and the terminals 62 of the reinforcement 44 (the bottom wall portion 48) are connected to the main body 30A of the corresponding motor 30 from the vehicle front side when this is performed.

The turn lamp 70 is assembled to the visor body 16 from the vehicle front side, and the first input connector 70A of the turn lamp 70 is assembled to the first output connector 66 of the reinforcement 44, and the second input connector 72A of the lighting lamp 72 is assembled to the second output connector 68 of the reinforcement 44 from the vehicle front side.

Lastly, the visor cover 20 (the upper cover 20A and the lower cover 20B) is assembled to the visor body 16 and the reinforcement 44 from the vehicle front side using the sixth screw 18F.

Note that the inside of the covering wall 16C is open at the vehicle front side of the visor body 16 (on the opposite side to the mirror body 38), the reinforcement 44 is assembled to the vehicle front side of the visor body 16, and the bottom wall portion 48 of the reinforcement 44 covers the vehicle front side of the mirror face adjustment mechanism 28 inside the covering wall 16C. This enables the mirror face adjustment mechanism 28 to be assembled at the inside of the covering wall 16C from the vehicle front side of the visor body 16 in a state in which the reinforcement 44 has not yet been assembled to the vehicle front side of the visor body 16.

This enables the mirror face adjustment mechanism 28 to also be assembled to the visor body 16 from the side from which the stowing mechanism 12, the reinforcement 44, the turn lamp 70, the lighting lamp 72, and the visor cover 20 are assembled to the visor body 16 (from the vehicle front side). This enables the number of processes to assemble the vehicle door mirror device 10 to be reduced, enabling the assembly line of the vehicle door mirror device 10 to be simplified, enabling the ease of assembly to be improved, and enabling costs to be reduced, in contrast to in cases in which the mirror face adjustment mechanism 28 is assembled to the visor body 16 from the vehicle rear side (the side corresponding to the mirror body 38). Moreover, damage to the visor cover 20 during assembly of the vehicle door mirror device 10 can be suppressed, enabling the proportion of defective vehicle door mirror devices 10 to be reduced.

Moreover, the reinforcing plate 46 of the reinforcement 44 is fixed to the swing body 12B of the stowing mechanism 12, the bottom wall portion 48 of the reinforcement 44 reinforces the support wall 16B, the covering wall 16C, and the coupling wall 16D of the visor body 16, and the fit-insertion column 48C of the bottom wall portion 48 reinforces the retention cylinder 26 of the visor body 16. The mirror face adjustment mechanism 28 and the retention cylinder 26 at the inside of the support wall 16B and the covering wall 16C support the mirror body 38. This enables the support rigidity of the support wall 16B, the covering wall 16C, the coupling wall 16D, the retention cylinder 26, and the mirror face adjustment mechanism 28 by the swing body 12B to be raised by the reinforcement 44, enabling the support rigidity of the mirror body 38 by the swing body 12B to be raised. This enables vibration of the support wall 16B, the covering wall 16C, the coupling wall 16D, the retention cylinder 26, and the mirror face adjustment mechanism 28 to be suppressed, thereby enabling vibration of the mirror body 38 to be suppressed, even if the housing wall 16A of the visor body 16 vibrates.

Furthermore, the reinforcing plate 46 of the reinforcement 44 is fixed to the swing body 12B, thus reinforcing the swing body 12B. This enables the support rigidity of the support wall 16B, the covering wall 16C, the coupling wall 16D, the retention cylinder 26, and the mirror face adjustment mechanism 28 by the swing body 12B to be effectively raised, enabling the support rigidity of the mirror body 38 by the swing body 12B to be effectively raised.

Moreover, the linking wall 50 is provided between the reinforcing plate 46 and the bottom wall portion 48 of the reinforcement 44. The linking wall 50 enables the rigidity of the reinforcement 44 to be effectively raised, enabling the reinforcement 44 to effectively reinforce the swing body 12B and the visor body 16, and enabling the support rigidity of the mirror body 38 by the swing body 12B to be still more effectively raised.

Furthermore, the fitting projections 50F respectively formed to the upper zigzag wall portion 50C and the lower zigzag wall portion 50E of the linking wall 50 of the reinforcement 44 are fitted into the fitting recesses 12C in the swing body 12B. This enables the reinforcement 44 to still more effectively reinforce the swing body 12B, enabling the support rigidity of the mirror body 38 by the swing body 12B to be still more effectively raised.

Moreover, the upper zigzag wall portion 50C and the lower zigzag wall portion 50E of the reinforcement 44 are fixed to the swing body 12B at the portions where the fitting projections 50F and the fitting recesses 12C fit together. This enables the reinforcement 44 to still more effectively reinforce the swing body 12B, enabling the support rigidity of the mirror body 38 by the swing body 12B to be still more effectively raised.

Furthermore, the partitioning walls 58A, 58B are provided to the central wall portion 50A of the linking wall 50 of the reinforcement 44. The partitioning walls 58A project toward the vehicle width direction inside from the vehicle width direction inside face of the vehicle width direction outside wall portion of the central wall portion 50A, and the partitioning walls 58B project toward the vehicle width direction outside from the vehicle width direction outside face of the vehicle width direction outside wall portion of the central wall portion 50A. Moreover, the partitioning walls 58A, 58B oppose each other along the vehicle width direction across the central wall portion 50A.

Thus, a cross-section area sectioned along the vehicle width direction at portions of the central wall portion 50A of the linking wall 50 of the reinforcement 44 where the partitioning walls 58A, 58B are formed is larger than that at portions of the central wall portion 50A where the partitioning walls 58A, 58B are not formed. This raises the bending rigidity of the central wall portion 50A with respect to bending load in a direction about an axis with an axial direction in the vehicle width direction. This enables the reinforcement 44 to still more effectively reinforce the swing body 12B and the visor body 16, enabling the support rigidity of the mirror body 38 by the swing body 12B to be still more effectively raised.

Moreover, the vehicle rear side ends of the partitioning walls 58B of the reinforcement 44 are joined to the vehicle rear side face of the bottom wall portion 48 of the reinforcement 44, and the vehicle rear side ends of the partitioning walls 58A of the reinforcement 44 are in the same plane as the vehicle rear side face of the vehicle width direction inside portion of the bottom wall portion 48. This improves rigidity with respect to bending load in a direction about an axis with an axial direction in the vehicle up-down direction at the portion of the first bend portion 51A of the reinforcement 44 disposed corresponding to the central wall portion 50A of the linking wall 50.

Moreover, the vehicle front side ends of the partitioning walls 58A of the reinforcement 44 are joined to the vehicle rear side face of the reinforcing plate 46 of the reinforcement 44, and the vehicle front side ends of the partitioning walls 58B of the reinforcement 44 are in the same plane as the vehicle front side face of the vehicle width direction outside portion of the reinforcing plate 46. This improves rigidity with respect to bending load in a direction about an axis with an axial direction in the vehicle up-down direction at the portion of the second bend portion 51B of the reinforcement 44 disposed corresponding to the central wall portion 50A of the linking wall 50.

In this manner, rigidity with respect to bending load is improved at the portion of the first bend portion 51A of the reinforcement 44 disposed corresponding to the central wall portion 50A of the linking wall 50, and at the portion of the second bend portion 51B of the reinforcement 44 disposed corresponding to the central wall portion 50A of the linking wall 50. This enables the reinforcement 44 to still more effectively reinforce the swing body 12B and the visor body 16, enabling the support rigidity of the mirror body 38 by the swing body 12B to be still more effectively raised.

Moreover, the partitioning walls 58A, 58B are disposed between the exposed portions 56A of the conductor lines 56 so as to follow the conductor lines 56, thereby enabling rigidity at the portions of the central wall portion 50A of the linking wall 50 of the reinforcement 44 where the conductor lines 56 are disposed to be effectively improved. Thus, even if load such as bending load or torsional load is applied to the central wall portion 50A, deformation can be effectively suppressed at the portions of the central wall portion 50A where the conductor lines 56 are disposed, enabling deformation, snapping, or the like of the conductor lines 56 to be effectively suppressed.

Thus, in the present exemplary embodiment, the reinforcement 44 is capable of reinforcing the swing body 12B and the visor body 16 still more effectively even if the reinforcement 44 is configured by a molded component made of a synthetic resin material, enabling support rigidity of the mirror body 38 by the swing body 12B to be still more effectively raised. This enables increased degrees of freedom for the design of the reinforcement 44, for example with respect to the shape of the linking wall 50 of the reinforcement 44, compared for example to a configuration in which the reinforcement 44 is formed by press-forming metal.

Furthermore, providing the partitioning walls 58A, 58B to the central wall portion 50A of the linking wall 50 of the reinforcement 44 enables the mechanical strength of the central wall portion 50A to be increased, enabling rigidity such as bending rigidity to be raised without increasing the thickness of the central wall portion 50A. This enables an increase in the weight of the reinforcement 44 to be suppressed and enables the material cost of the reinforcement 44 to be suppressed, therefore enabling an increase in the weight of the vehicle door mirror device 10 to be suppressed and enabling the manufacturing cost of the vehicle door mirror device 10 to be suppressed.

The assembly plates 48B are formed at the radial direction outside of the bottom wall portion 48 of the reinforcement 44, and the assembly plates 48B are fixed to the visor body 16 at the outside of the wheel drives 34 and the rod drives 36 of the mirror face adjustment mechanism 28 in the radial direction of the bottom wall portion 48. This enables the bottom wall portion 48 (including the support cylinders 48D) to effectively limit movement of the wheel drives 34, enabling the support rigidity of the wheel drives 34 and the rod drives 36 by the bottom wall portion 48 to be effectively raised, and enabling operation of the mirror face adjustment mechanism 28 to be effectively stabilized.

Furthermore, the limiting plates 22 of the visor body 16 are inserted into the limiting holes 54 in the bottom wall portion 48 at the perimeter of the mirror face adjustment mechanism 28, thereby limiting movement of the bottom wall portion 48 in the circumferential direction and the radial direction with respect to the visor body 16. This enables the bottom wall portion 48 (including the support cylinders 48D) to still more effectively limit movement of the wheel drives 34, enabling the support rigidity of the wheel drives 34 and the rod drives 36 by the bottom wall portion 48 to be still more effectively raised, and enabling operation of the mirror face adjustment mechanism 28 to be still more effectively stabilized.

Moreover, the vehicle rear side portion of the circumferential fitting wall 48A of the bottom wall portion 48 is inserted into the outer recess 24 of the visor body 16, the vehicle front side end of the support wall 16B of the visor body 16 is inserted into the inner recess 52 of the bottom wall portion 48, the outer peripheral face of the circumferential fitting wall 48A is fitted into the fitting cylinder 16E of the visor body 16, and the outer peripheral face of the support wall 16B is fitted together with the outer peripheral face of the inner recess 52 (the inner peripheral face of the circumferential fitting wall 48A). This enables an incursion path of foreign matter (such as water) from the vehicle front side of visor body 16, between the bottom wall portion 48 and the visor body 16, and to the inside of the covering wall 16C to be lengthened, enabling the incursion of foreign matter to the inside of the covering wall 16C to be suppressed, and thus enabling the incursion of foreign matter into the mirror face adjustment mechanism 28 (in particular the motors 30) to be suppressed.

Furthermore, the swing body 12B of the stowing mechanism 12, the visor body 16, the visor cover 20, the turn lamp 70, and the lighting lamp 72 are assembled to the reinforcement 44 that has a high rigidity. This enables rattling between the swing body 12B, the visor body 16, the visor cover 20, the turn lamp 70, and the lighting lamp 72 to be suppressed, even in cases in which dimensional tolerance is present in at least one out of the swing body 12B, the visor body 16, the visor cover 20, the turn lamp 70, or the lighting lamp 72.

Moreover, the conductor lines 56, the main connector 60, the terminals 62, the first output connector 66, and the second output connector 68 are integrally provided to the reinforcement 44, the motors 30 are electrically connected to the terminals 62, and the turn lamp 70 (the first input connector 70A) and the lighting lamp 72 (the second input connector 72A) are respectively electrically connected to the first output connector 66 and the second output connector 68. This enables the need to electrically connect the main connector 60 to the motors 30, and the turn lamp 70 and the lighting lamp 72 using harnesses separate to the reinforcement 44 to be eliminated. This enables the need to route harnesses to be eliminated, enabling the number of assembly processes of the vehicle door mirror device 10 to be reduced. Moreover, this enables flapping of harnesses to be eliminated, enabling the occurrence of noise to be suppressed and enabling disconnection of the conductor lines 56 to be suppressed.

Furthermore, the partitioning walls 58A, 58B and the suppressing walls 64 project from, and are integrally provided to, the reinforcement 44, the partitioning walls 58A, 58B cover the upper side of the exposed portions 56A of the conductor lines 56, and the suppressing walls 64 cover the portions of the terminals 62 that are exposed through the reinforcement 44 from the upper side and both vehicle width direction sides. Foreign matter such as water can accordingly be suppressed from reaching the exposed portions 56A of the conductor lines 56 by the partitioning walls 58A, 58B, and foreign matter such as water can be suppressed from reaching the exposed portions of the terminals 62 by the suppressing walls 64, enabling the exposed portions 56A of the conductor lines 56 and the exposed portions of the terminals 62 to be protected.

Moreover, the partitioning walls 58A, 58B are disposed between the exposed portions 56A of the conductor lines 56. This enables foreign matter such as water to be suppressed from forming a connection between the exposed portions 56A of the conductor lines 56, enabling an electrical connection between the exposed portions 56A of the conductor lines 56 to be suppressed.

Furthermore, since foreign matter such as water can be suppressed from adhering to the exposed portions 56A of the conductor lines 56, the exposed portions 56A do not need to be covered, enabling a covering process to cover the exposed portions 56A using a vehicular insulating material to be omitted from the manufacturing processes of the vehicle door mirror device 10.

Moreover, the lighting lamp 72 is disposed further toward the vehicle width direction inside (the side corresponding to the bottom wall portion 48) than the linking wall 50 of the reinforcement 44. This enables the need to provide a separate space in which to dispose the lighting lamp 72 to be eliminated, enabling the vehicle door mirror device 10 to be made smaller in size in the vehicle front-rear direction.

Note that in the present exemplary embodiment, the vehicle front side ends of the partitioning walls 58A of the linking wall 50 of the reinforcement 44 are joined to the vehicle rear side face of the reinforcing plate 46 of the reinforcement 44, and the vehicle rear side ends of the partitioning walls 58A are in the same plane as the vehicle rear side face of the vehicle width direction inside portion of the bottom wall portion 48 of the reinforcement 44. However, the vehicle front side ends of the partitioning walls 58A may be disposed further toward the vehicle rear side than the vehicle rear side face of the reinforcing plate 46, and the vehicle rear side ends of the partitioning walls 58A may be disposed further toward the vehicle front side or vehicle rear side than the vehicle rear side face of the vehicle width direction inside portion of the bottom wall portion 48.

Moreover, in the present exemplary embodiment, the vehicle rear side ends of the partitioning walls 58B of the linking wall 50 of the reinforcement 44 are joined to the vehicle rear side face of the bottom wall portion 48 of the reinforcement 44, and the vehicle front side ends of the partitioning walls 58B are in the same plane as the vehicle front side face of the vehicle width direction outside portion of the reinforcing plate 46 of the reinforcement 44. However, the vehicle rear side ends of the partitioning walls 58B may be disposed further toward the vehicle front side than the vehicle rear side face of the bottom wall portion 48, and the vehicle front side ends of the partitioning walls 58B may be disposed further toward the vehicle front side or vehicle rear side than the front side face of the vehicle width direction outside portion of the reinforcing plate 46.

Furthermore, although there is no particular mention of the numbers of the partitioning walls 58A, 58B of the linking wall 50 of the reinforcement 44 in the present exemplary embodiment, one or plural of each of the partitioning walls 58A, 58B may be provided.

Moreover, although in the present exemplary embodiment the partitioning walls 58A, 58B of the linking wall 50 of the reinforcement 44 are disposed between the exposed portions 56A of the conductor lines 56 so as to follow the conductor lines 56, the partitioning walls 58A, 58B may be provided at positions at an appropriate spacing away from the placement positions of the conductor lines 56, or away from the placement positions of the exposed portions 56A of the lines 56. Furthermore, although the conductor lines 56 are provided to the reinforcement 44 in the present exemplary embodiment, the present invention may also be applied to a configuration in which the conductor lines 56 are not provided to the reinforcement 44.

Moreover, in the present exemplary embodiment the partitioning walls 58A and the partitioning walls 58B of the linking wall 50 of the reinforcement 44 are provided so as to oppose each other along the vehicle width direction across the central wall portion 50A of the linking wall 50. However, the partitioning walls 58A may be provided so as to be offset from the partitioning walls 58B along the vehicle width direction.

Furthermore, in the present exemplary embodiment both the partitioning walls 58A and the partitioning walls 58B are provided to the central wall portion 50A of the linking wall 50 of the reinforcement 44. However, a configuration may be applied in which either one out of the partitioning walls 58A or the partitioning walls 58B is provided to the central wall portion 50A.

Moreover, the partitioning walls 58A, 58B, serving as reinforcing sections, are provided to the central wall portion 50A of the linking wall 50, serving as a first extension portion, of the reinforcement 44 in the present exemplary embodiment. However, the partitioning walls 58A or the partitioning walls 58B may be provided to a portion of the linking wall 50 other than the central wall portion 50A, such as the upper wall portion 50B, the lower wall portion 50D, the upper zigzag wall portion 50C, or the lower zigzag wall portion 50E of the linking wall 50. Namely, as long as the partitioning walls 58A and the partitioning walls 58B are formed projecting from the linking wall 50, serving as a first extension portion, and are able to reinforce the linking wall 50, there is no limitation to their specific implementation.

Further, the support wall 16B and the covering wall 16C are integral to the housing wall 16A in the present exemplary embodiment. However, a configuration may be applied in which at least one out of the support wall 16B or the covering wall 16C is configured by a separate body to the housing wall 16A.

Furthermore, in the present exemplary embodiment, a detection mechanism (a memory unit, electrical mechanism) may be provided that is supplied with electrical power in order to detect a movement position of the rod drives 36, for example, and thereby detect a tilt position of the mirror body 38. In such cases, for example, the detection mechanism may be assembled to the reinforcement 44 (in particular, the vehicle front side of the bottom wall portion 48), and the detection mechanism may be electrically connected to the conductor lines 56 of the reinforcement 44.

Moreover, in the present exemplary embodiment, the mirror body 38 serves as a visual recognition section. However, a camera that performs imaging to assist occupant visual recognition may serve as the visual recognition section. In such cases, the camera may be electrically connected to the conductor lines 56 of the reinforcement 44.

Furthermore, in the present exemplary embodiment, the vehicle door mirror device 10 (vehicle visual recognition device) is installed at the outside of a door of a vehicle. However, the vehicle visual recognition device may be installed at another position on a vehicle.

The entire content of the disclosure of Japanese Patent Application No. 2016-182304 filed on Sep. 16, 2016 is incorporated by reference in the present specification.

1. A vehicle visual recognition device comprising:
a visual recognition section that assists visual recognition by an occupant of a vehicle;
an operating mechanism that is operated so as to tilt the visual recognition section; a housing body that houses the visual recognition section;
a covering member that includes a covering section to cover the operating mechanism from the opposite side to the visual recognition section, that is fixed to the housing body, that is bent with respect to the covering section at a first bend portion joined to the covering section, and that includes a first extension portion extending from the first bend portion; and
a reinforcing section that projects from the first extension portion and that reinforces the covering member.

2. The vehicle visual recognition device of claim 1, wherein the reinforcing section is provided at a portion of the covering member that includes the first bend portion, and is joined to both the covering section and the first extension portion.

3. The vehicle visual recognition device of claim 1, wherein the covering member includes:
a second bend portion that is bent with respect to the first extension portion; and a second extension portion that extends from the second bend portion.

4. The vehicle visual recognition device of claim 3, wherein the reinforcing section is provided at a portion of the covering member that includes the second bend portion, and is joined to both the first extension portion and the second extension portion.

5. The vehicle visual recognition device of claim 3, wherein:
the second extension portion is provided on the opposite side of the first extension portion from the covering section; and
the reinforcing section is provided so as to join together a covering section side end and a second extension portion side end of the first extension portion.

6. The vehicle visual recognition device of claim 3, wherein reinforcing sections are provided on both sides of the first extension portion.

7. The vehicle visual recognition device of claim 6, wherein the reinforcing section provided on one side of the first extension portion is provided opposing the reinforcing section provided on the other side of the first extension portion.

8. The vehicle visual recognition device of claim 1, further comprising an electrical connection section that is provided at the covering member and that is electrically connected to the operating mechanism, the reinforcing section being provided beside a placement position of the electrical connection section on the first extension portion.

9. The vehicle visual recognition device of claim 8, further comprising a plurality of electrical connection sections, the reinforcing section being provided between the plurality of electrical connection sections.
